(19) United States
(12) Patent Application Publication
(10) Pub. No.: US 2024/0229490 A1
(43) Pub. Date: Jul. 11, 2024

(54) Systems And Methods For Smart Valve Control Of Pool And Spa Components And Operations

(71) Applicant: Hayward Industries, Inc., Charlotte, NC (US)

(72) Inventors: Kevin Doyle, Pompano Beach, FL (US); William Weiss, Parkland, FL (US); Troy Renken, Mooresville, NC (US)

(73) Assignee: Hayward Industries, Inc., Charlotte, NC (US)

(21) Appl. No.: 18/542,549

(22) Filed: Dec. 15, 2023

Related U.S. Application Data
(60) Provisional application No. 63/433,081, filed on Dec. 16, 2022.

(51) Int. Cl. E04H 4/12; E04H 4/16

(52) U.S. Cl. CPC E04H 4/1245; E04H 4/16

(57) ABSTRACT

Systems and methods for smart valve control of pool and spa components and operations are provided. A smart valve system is provided which includes a multiplexed communications link between the smart valve system and a pool/spa control system which allows for a plurality of relays of the pool/spa control system to control a plurality of valves of the smart valve system using a single data communications cable connected between the smart valve system and the pool/spa control system. The smart valve system allows for calibration and control of a pumping system, such as a variable speed pumping system. The smart valve system optimizes operation and heat transfer of a solar heater in fluid communication with the smart valve system. The smart valve system allows for control and optimization of a pool cleaner in fluid communication with the smart valve system. The smart valve system allows for control and optimization of a gas heater in fluid communication with the smart valve system. The smart valve system detects dirty filter conditions, and assists a priming operation of a pump, detects low pool water conditions and automatically remedies such conditions, and detects and mitigates pump cavitation. In still further embodiments, the smart valve system controls fluid flow to a chlorinator.

### BACKGROUND

### Related Applications

This application claims the benefit of priority to U.S. Provisional Patent Application No. 63/433,081 filed on Dec. 16, 2022, the entire contents of which are expressly incorporated by reference herein.

### Field of the Invention

The present disclosure relates to pool and spa equipment. More particularly, the present disclosure relates to systems and methods for smart valve control of pool and spa components and operations.

### RELATED ART

In the pool and spa industry, proper control of pool and spa components is of paramount concern. Increasingly, automated control systems are being implemented in various commercial and residential pool and spa installations. Such control systems allow for centralized and/or remote control of various pool and spa components such as pumps, heaters, lights, filters, valves, sanitization systems, and other components.

“Smart” valve controllers are a type of pool and spa device which allow for centralized and/or remote control of fluid flowing through various fluid “branches” of a pool/spa installation. Such valve controllers include a plurality of valves that are controlled by valve actuators, one or more sensor for sensing fluid conditions such as flow rates, and a controller (processor) which controls actuation of the valve actuators and which processes the sensed fluid conditions. Such systems may also include a communications interface that allows for wired or wireless communications of such systems to other devices, such as a centralized pool/spa control system.

It would be advantageous to extend and improve the ability of smart valve controllers to remotely control other pool/spa devices and to optimize overall pool operations such as filtering, heating, sanitization, etc. Accordingly, the systems and methods disclosed herein address the foregoing and other needs.

### SUMMARY

The present disclosure relates to systems and methods for smart valve control of pool and spa components and operations. In one embodiment, a smart valve system is provided which includes a multiplexed communications link between the smart valve system and a pool/spa control system which allows for a plurality of relays of the pool/spa control system to control a plurality of valves of the smart valve system using a single data communications cable connected between the smart valve system and the pool/spa control system. In another embodiment, the smart valve system allows for calibration and control of a pumping system, such as a variable speed pumping system. In a further embodiment, the smart valve system optimizes operation and heat transfer of a solar heater in fluid communication with the smart valve system. In still a further embodiment, the smart valve system allows for control and optimization of a pool cleaner in fluid communication with the smart valve system. In an additional embodiment, the smart valve system allows for control and optimization of a gas heater in fluid communication with the smart valve system. In further embodiments, the smart valve system detects dirty filter conditions, and assists a priming operation of a pump, detects low pool water conditions and automatically remedies such conditions, and detects and mitigates pump cavitation. In still further embodiments, the smart valve system controls fluid flow to a chlorinator.

### BRIEF DESCRIPTION OF THE DRAWINGS

The foregoing features of the invention will be apparent from the following Detailed Description, taken in connection with the accompanying drawings, in which:

FIG. 1 is a block diagram of a first embodiment of the smart valve system of the present disclosure, wherein multiplexed data communications over a single data communications cable is provided between the smart valve system and a pool/spa controller;

FIG. 2 is a flowchart illustrating steps carried out by the system of FIG. 1.

FIG. 3 is a block diagram of a second embodiment of the smart valve system of the present disclosure, wherein the smart valve system allows for calibration and optimization of pumping performed by a pump in fluid communication with the smart valve system;

FIGS. 4-6 are flowcharts illustrating steps carried out by the system of FIG. 3;

FIG. 7 is a block diagram of a third embodiment of the smart valve system of the present disclosure, wherein the smart valve system optimizes operation and heat transfer of a solar heater in communication with the smart valve system;

FIG. 8 is a flowchart illustrating steps carried out by the system of FIG. 7;

FIG. 9 is a block diagram of a fourth embodiment of the smart valve system of the present disclosure, wherein the smart valve system allows for control and optimization of a pool cleaner in fluid communication with the smart valve system;

FIG. 10 is a flowchart illustrating steps carried out by the system of FIG. 9;

FIG. 11 is a block diagram of a fifth embodiment of the smart valve system of the present disclosure, wherein the smart valve system controls and optimizes operation of a gas heater in fluid communication with the smart valve system;

FIG. 12 is a flowchart illustrating steps carried out by the system of FIG. 11;

FIG. 13 is a block diagram illustrating a sixth embodiment of the smart valve system of the present disclosure, wherein the smart valve system detects dirty filter conditions;

FIGS. 14-16 are flowcharts illustrating steps carried out by the system of FIG. 13;

FIGS. 17-18 are flowcharts illustrating a seventh embodiment of the smart valve system of the present disclosure, wherein the smart valve system assists a priming operation of a pump in fluid communication with the smart valve system;

FIG. 19 is a block diagram illustrating an eighth embodiment of the smart valve system of the present disclosure, wherein the smart valve system detects low pool water conditions and automatically remedies such conditions;

FIG. 20 is a flowchart illustrating steps carried out by system of FIG. 19;

FIG. 21 is a flowchart illustrating a ninth embodiment of the smart valve system of the present disclosure, wherein the smart valve system detects and mitigates pump cavitation;

FIG. 22 is a flowchart illustrating a tenth embodiment of the smart vale system of the present disclosure, wherein the smart valve system optimizes a flow rate for a chlorinator;

FIG. 23 is a flowchart illustrating an eleventh embodiment of the smart valve system of the present disclosure, wherein the smart valve system initiates a sloughing cycle to clean a chlorinator;

FIG. 24 is a diagram illustrating a twelfth embodiment of the smart valve system of the present disclosure, wherein the smart valve system provides for audio/visual control of a water show;

FIG. 25 is a diagram illustrating a thirteenth embodiment of the smart valve system of the present disclosure, wherein the smart valve system includes suction and return valve controllers and associated components for providing various skimming and cleaner control operations; and

FIG. 26 is a diagram illustrating a fourteenth embodiment of the smart valve system of the present disclosure, wherein the smart valve system includes pressure transducers for controlling flow of various fluid paths without requiring flow meters.

### DETAILED DESCRIPTION

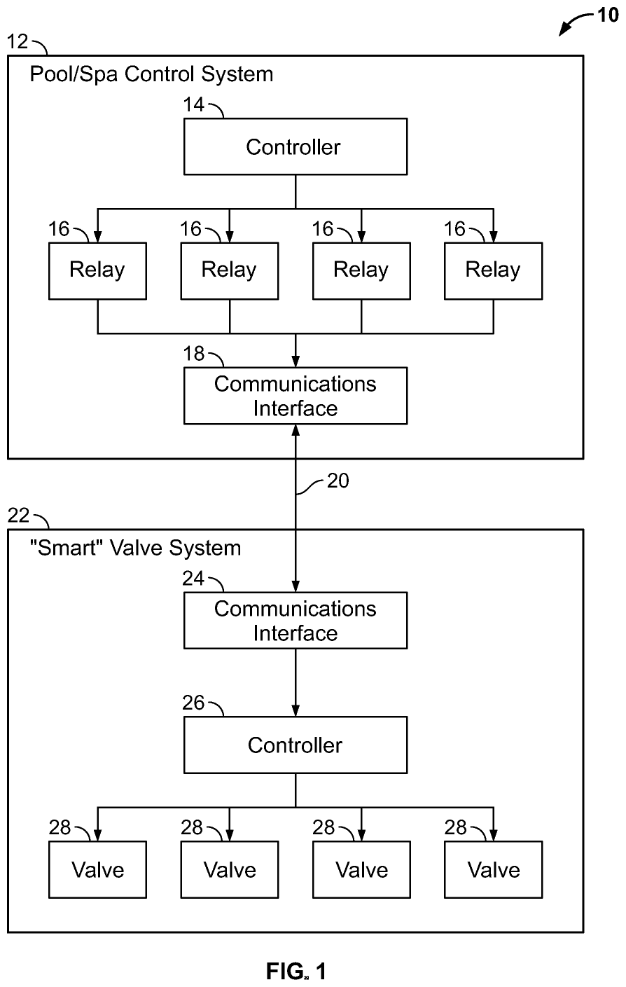

The present disclosure relates to systems and methods for smart valve control of pool and spa equipment and operations, as discussed in detail below in connection with FIGS. 1-26. It is noted that the smart valve systems discussed herein in connection with FIGS. 1-26 could comprise one or more of the fluid handling and/or distribution systems (including the manifolds thereof and associated components) disclosed in U.S. Pat. No. 11,137,780, which is expressly incorporated herein by reference in its entirety and made a part hereof, configured and/or modified to provide the specific features discussed herein.

FIG. 1 is a block diagram, indicated generally at 10, of a first embodiment of the smart valve system of the present disclosure, wherein multiplexed data communications over a single data communications cable is provided between the smart valve system and a pool/spa controller. As can be seen, the smart valve system 22 can be controlled by a pool/spa control system 12 via a multiplexed communications interface that allows for data communications and exchange over a single data cable 20. Specifically, the pool/spa control system 12 includes a controller 14, one or more relays 16, and a communications interface 18 that communicates with the data cable 20. The data cable 20 is in communication with a second communications interface 24 positioned within the smart valve system 22. The communications interface 18 of the pool/spa control system 12 reads outputs of the one or more relays 16, converts such outputs into a formatted message (e.g., a serial data signal), and communicates the converted relay outputs over the data cable 20 to the communications interface 24 of the smart valve system 22. The communications interface 24 of the smart valve system 20 receives the formatted message and converts the formatted message into control signals that can be executed by the controller 26 to control one or more valve controllers associated with the valves 28 of the smart valve system 22. Advantageously, such a configuration allows multiple relay outputs of the pool/spa control system 12 to remotely control one or more of the valves 28, without requiring multiple cables to be connected between the pool/spa control system 12 and the smart valve system 22. Instead, only a single, relatively thin and lightweight data cable 20 is required to allow communications to occur between the pool/spa control system 12 and the smart valve system 22. It is noted that the communications cable 20 could support one or more suitable serial communications protocols, such as the RS-485 communications protocol, or other suitable protocol.

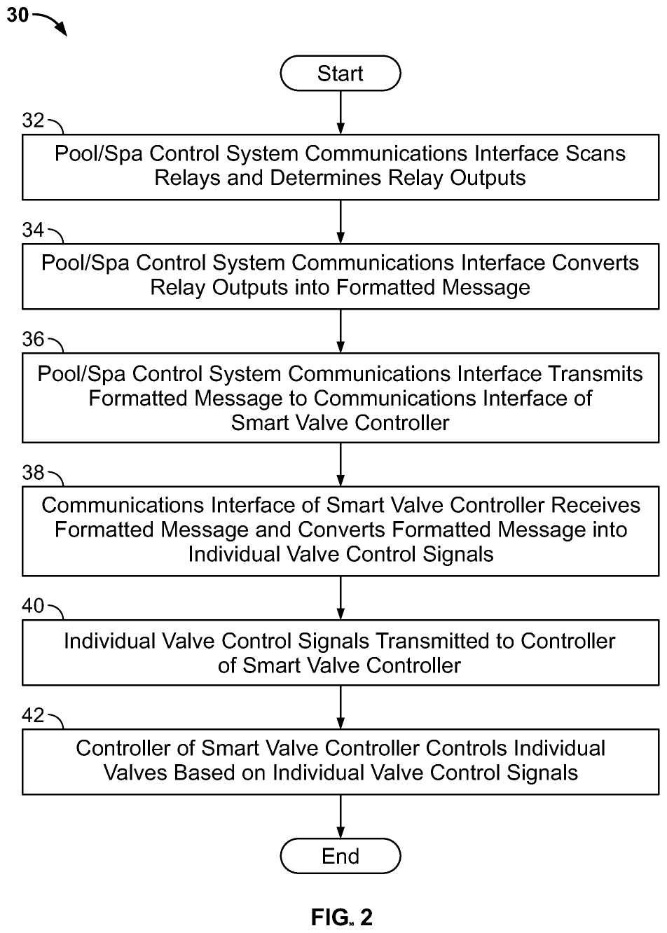

FIG. 2 is a flowchart, indicated generally at 30, illustrating steps carried out by the system of FIG. 1. Beginning in step 32, the communications interface 18 of the pool/spa control system 12 scans outputs of the relays 16 and determines the output status of each relay. Next, in step 34, the pool/spa control system communications interface 18 converts the relay output into a formatted message. Subsequently, in step of 36, the pool/spa control system communications interface 18 transmits the formatted message to the communications interface 24 of the smart valve system 22. Next, in step 38, the communications interface 24 of the smart valve system 22 receives a formatted message and converts the formatted message into individual valve control signals. In step 40, the individual valve control signals are transmitted to the controller 26 of the smart valve system 22. Finally, in step 42, the controller 26 of the smart valve system 22 controls the individual valve control is 28 based on individual valve control signals processed by the controller 26.

Existing “AUX OUT” 24 VAC relay outputs are binary (ON or OFF) and are used to control valve actuators, as one example. Converting multiple binary outputs into an RS-485 message to send to the smart valve system 22 allows for a smaller cable and avoids wiring mistakes. Reading the AUX OUT signals, the “spider” detects which valve actuators should be ON or OFF and then communicates that information to the smart valve system 22. For a particular valve actuator, the smart valve system 22 can be programmed to set the flow to a specific flow rate when it receives an ON command. For example, if valve actuator #1 is controlling a bubbler and its programmed (at the smart valve 22) flow rate is 20 gallons per minute (GPM), whenever the controller's AUX OUT output for the valve actuator is ON, the smart valve 22 will deliver 20 GPM (as opposed to the existing technology where the valve actuator is opened to 100% or a preset partially open position). Advantageously this allows for backwards compatibility with existing pool controllers to more accurately and consistently deliver the desired flow rate to water features, equipment, etc.

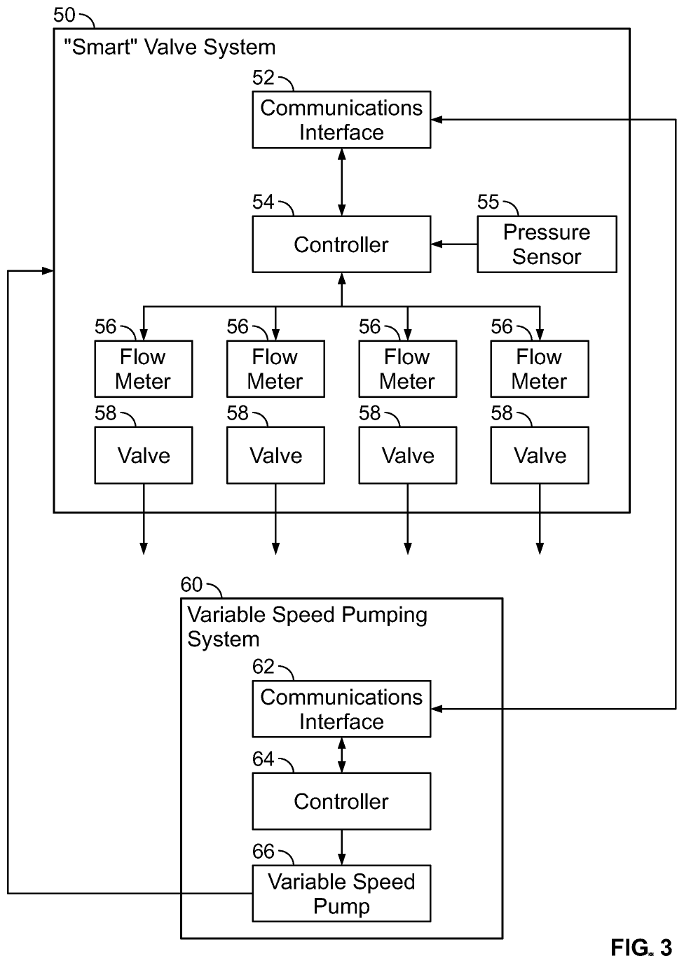

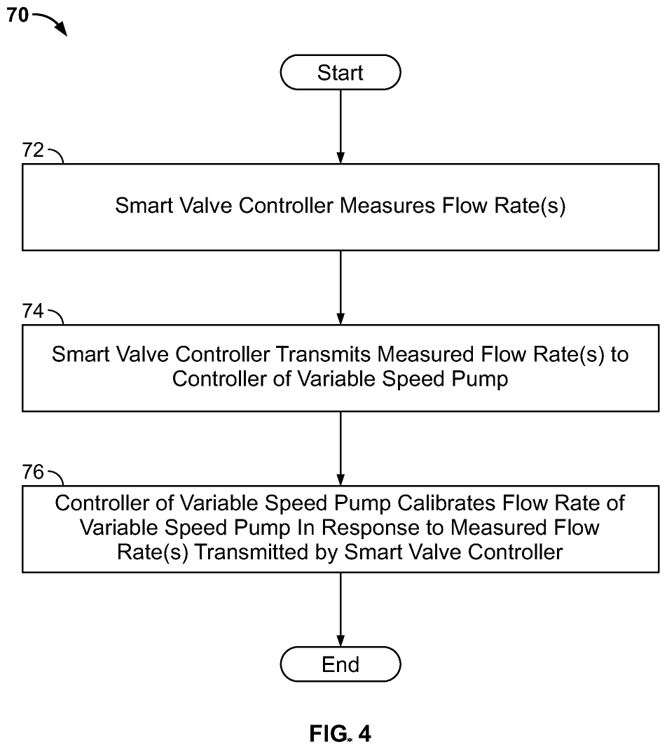

FIG. 3 is a block diagram of a second embodiment of the smart valve system of the present disclosure, wherein the smart valve system allows for calibration and optimization of pumping performed by a pump in fluid communication with the smart valve system. Specifically, as seen in FIG. 3, the smart valve system 50 communicates with a variable speed pumping system 60 via communications interfaces 52, 62. The communications interfaces 52, 62 could provide a digital serial communications links, such as an RS-485 communications link. The smart valve system 50 includes a controller 54, one or more flow meters 56 for measuring water flow rates through one or more fluid branches of the smart valve system 50, and one or more valves 58 for controlling the flow of water through such branches. The variable speed pumping system 60 includes a dedicated controller 64 and a variable speed pump 66 controlled by the controller 64. The variable speed pump 66 pumps fluid such as water from a pool or spa to the smart valve system 50, for subsequent distribution to other pool and spa components via one or more branches controlled by the valves 58. As will be described in greater detail in connection with FIGS. 4-6, the smart valve system 50 provides various ways for remotely calibrating and controlling the variable speed pumping system 60. It is noted that the various monitoring and control functions of the controller 54 discussed herein need not be stored in the controller 54, and indeed, such control functions could be stored remotely from the smart valve system 50 (e.g., in a remote “cloud” server in communication with the smart valve system 50 via the communications interface 52, or in a smart phone software application in communication with the smart valve system 50). In such circumstances, the smart valve system 50 could be remotely monitored and controlled (e.g., via the cloud server, smart phone application, or some other control source).

It is additionally noted that the smart valve system 50 could also include one or more pressure sensors 55 in communication with the controller 54. Such sensors 55 could perform a variety of functions including, but not limited to, detecting pressure changes that are attributable to changes in the variable speed pumping system 60 (e.g., the pressures sensors 55 can detect changes in output of the pump 60 immediately, rather than waiting for averaged flow changes, which allows for much faster motor control and/or movement of one or more of the valves 58 to a final position), as well as for characterizing one or more fluid lines connected to one or more of the valves 58. For example, the controller 54 could run a calibration of the complete system with all of the valves 58 wide open to allow a singular vessel pressure and individual flow to be measured along the line head to be computed. This allows a fluid model developed by the controller 54 for each actuator of the valves 58 to be fine-tuned to its unique loading. For example, a valve that utilizes nearly the full range of valve motion at a given vessel pressure may be in sharp contrast to a valve that requires only 5% of the valve range for its complete range of motion or desired step change. A motion control algorithm executed by the controller 54 could take this into account, to avoid undershoot or overshoot conditions (typically, it is more desirable to have an overdamped response or to be critically damped to the final valve position rather than to overshoot and have to retrace).

FIG. 4 is a flowchart, indicated generally at 70, illustrating steps carried out by the system of FIG. 3. Beginning in step 72, the smart valve controller 54 measures flow rates of one or more fluidic branches of the smart valve system 50 using one or more of the flow meters 56. In step 74, the smart valve controller 54 transmits the measured flow rates to the controller 64 of the variable speed pumping system 60. Finally, in step 76, the controller 64 of the variable speed pumping system 60 calibrates a flow rate of the variable speed pump 66 in response to measured flow rates transmitted by the smart valve controller 54 to the variable speed pumping system 60. As can be appreciated, by remotely measuring the flows of various fluidic branches, the smart valve system 50 can use such information to remotely control and to calibrate a variable speed pumping system.

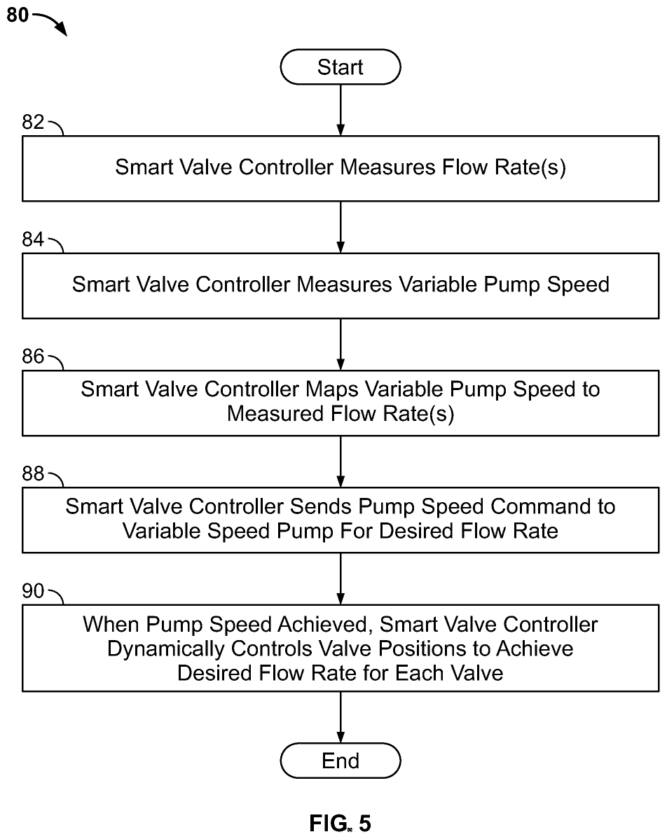

FIG. 5 is a flowchart, indicated generally at 80, showing additional steps capable of being carried out by the system of FIG. 3. Beginning and step 82, the smart valve controller 54 measures flow rates of one or more fluidic branches of the smart valve system 50 using one or more of the flow meters 56. Next, in step 84, the smart valve controller 54 measures a speed of the variable speed pumping system 60. This can be accomplished by requesting speed information from the variable speed pump thing system 60 using the communications interfaces 52, 62. In other words, the smart valve system 50 can remotely ascertain the speed of the variable speed pumping system 60, and can process such information as disclosed herein. In step 86, the smart valve controller 54 maps the speed of the variable speed pumping system to the measured flow rate. In step 88, the smart valve controller sends a pump speed command to the variable speed pump system 60 for the desired flow rate. Finally, in step 90, when the variable speed pumping system 60 achieve the desired pump speed, the smart valve controller 54 dynamically controls valve positions of the one or more valves 58 to achieve the desired flow rate for each valve (for each fluidic branch of the smart valve system 50).

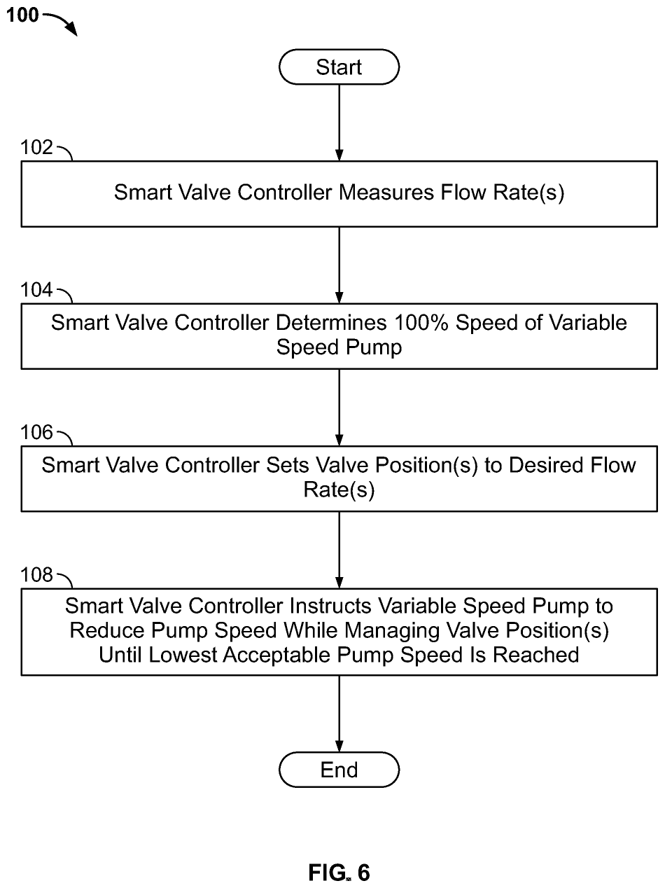

FIG. 6 is a flowchart indicating even further steps, indicated generally at 100, capable of being carried out by the system of FIG. 3. Specifically, in step 102, the smart valve controller 54 measures one or more flow rates of one or more fluidic branches of the smart valve system 50 using one or more of the flow meters 56. Next, in step 104, the smart valve controller 54 determines the full (100%) speed of the variable speed pump 66 of the variable speed pumping system 60. Such information could be programmed in advance into the smart valve system 50, or it could be obtained by the smart valve system 50 from the variable speed pumping system 60 using the communications interfaces 52, 62. Next, in step 106, the smart valve controller 54 sets one or more valve positions of one or more of the valves 58 to achieve desired flow rates. Finally, in step 108, the smart valve controller 54 instructs the controller 64 of the variable speed pumping system 60 to reduce the speed of the variable speed pump 66 while managing valve positions of the valves 58 until a lowest acceptable pump speed has been reached by the variable speed pump 66.

As discussed above in connection with FIGS. 3-6, the smart valve system 50 can use its flow meters to calibrate the variable speed pump's flow rate. Such configurations are of use for variable speed pumps that utilize an internal flow rate calculation and can be programmed to a specific GPM flow rate (which are historically not very accurate). It is noted that the smart valve system 50 can map the variable speed pump's speed to a measured flow rate at the smart valve. A benefit of mapping the pump speed to flow rate is that it provides a quick starting point for the smart valve to send a pump speed command for a desired flow rate. After that pump speed is reached, the smart valve will then dynamically control the valve positions to achieve the desired GPM flow rate for each valve. As noted above, it is also possible for the smart valve to map the 100% speed (e.g., 3450 RPM), set the valves positions to the desired flow rates, then gradually reduce the pump speed while managing valve positions until the lowest acceptable pump speed is reached.

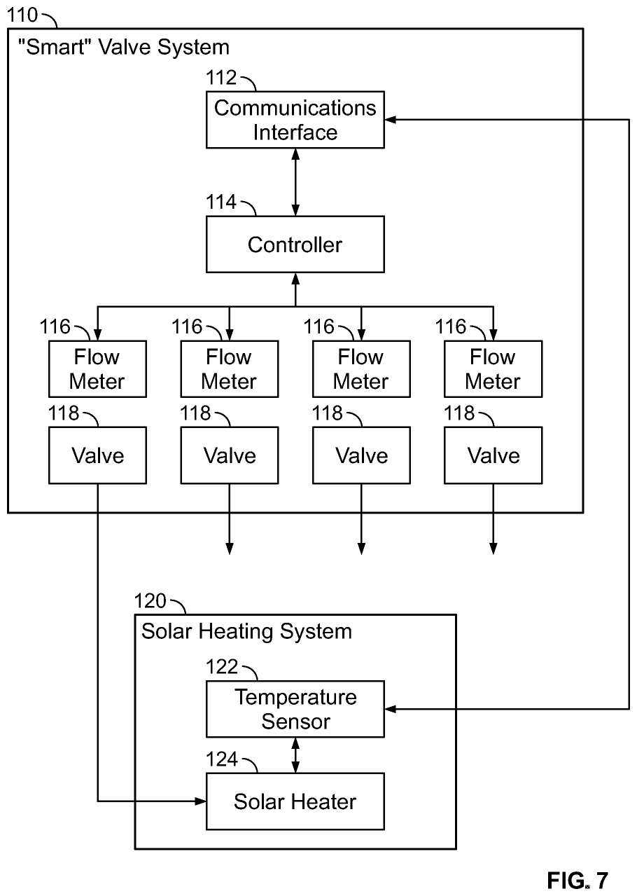

FIG. 7 is a block diagram of a third embodiment of the smart valve system of the present disclosure, wherein the smart valve system optimizes operation and heat transfer of a solar heater in communication with the smart valve system. Specifically, as shown in FIG. 7, the smart valve system 110 communicates with a solar heating system 120 using communications Interface 112, which reads temperature information from the solar heating system 120 using a temperature sensor 122 in communication with the communications interface 112. The smart valve system 110 also includes a controller 114 which receives the temperature information from the communications interface 112, and controls one or more valve controllers associated with one or more valves 118. As in prior embodiments, the smart valve system 110 also includes one or more flowmeters 116 for measuring fluid flow rates through one or more branches of the smart valve system 110. Additionally, the solar heating system 120 includes a solar heater 124 for heating pool or spa water. Water to be heated by the solar heater 124 is supplied by one of the valves 118 of the smart valve system 110. It is noted that the various monitoring and control functions of the controller 114 discussed herein need not be stored in the controller 114, and indeed, such control functions could be stored remotely from the smart valve system 110 (e.g., in a remote “cloud” server in communication with the smart valve system 110 via the communications interface 112, or in a smart phone software application in communication with the smart valve system 110). In such circumstances, the smart valve system 110 could be remotely monitored and controlled (e.g., via the cloud server, smart phone application, or some other control source).

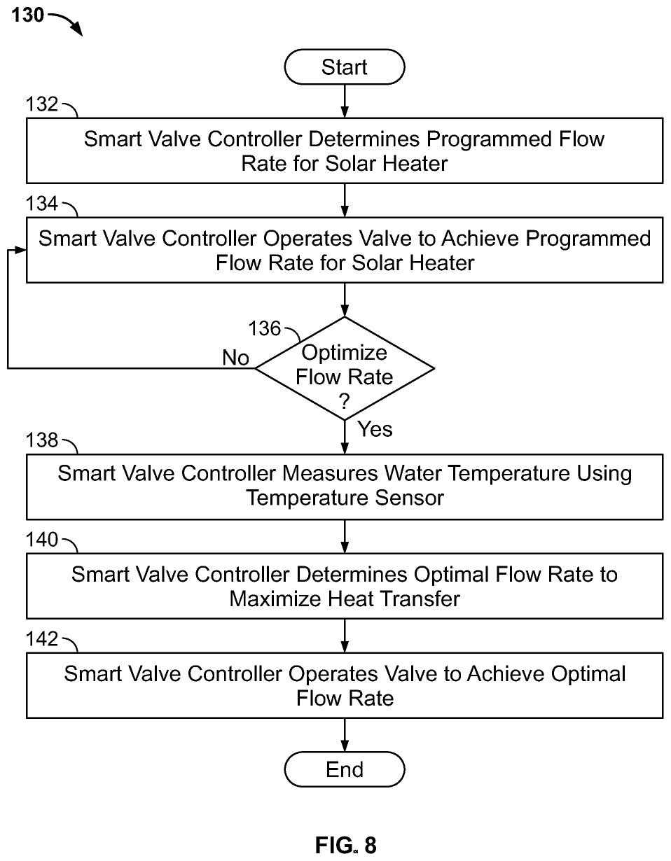

FIG. 8 is a flowchart, indicated generally at 130, showing steps carried out by the system of FIG. 7. Beginning in step 132, the smart valve controller 114 determines a programmed flow rate for the solar heater 124. Such information could be pre-programmed and stored in a memory of the smart valve system 110, or transmitted to the smart valve system 110 via the communications interface 112. In step 134, the smart valve controller 114 operates one or more of the valves 118 to achieve a programmed flow rate for the solar heater 124. In step 136, a determination is made as to whether an optimum flow rate has been achieved for the solar heater 124. If a negative determination has been made, control returns to step 134. Otherwise, if a positive determination is made, step 138 occurs, wherein the smart valve controller 114 measures a water temperature using the temperature sensor 122. Next, at step 140, the smart valve controller 114 determines an optimal flow rate to maximize heat transfer. Finally, in step 142, the smart valve controller 114 operates a valve 118 to achieve an optimal flow rate for the solar heating system 120.

The features discussed in connection with FIGS. 7-8 deliver a programmed flow rate through a solar heater for more consistent results, and optimize the flow rate through the solar heater to maximize the heat transfer. Since solar conditions are variable based on time of day, cloud cover, etc., the optimal flow rate will also change. If the output water temperature from the solar heater is monitored while the flow rate is increased, the optimal flow rate can be determined when the peak output temperature is reached. If the flow is too low, then the system did not transfer as much heat as was available. If the flow is too high, there is no added heat benefit and the pump is running inefficiently since it has the pump more water than necessary up to an elevated height.

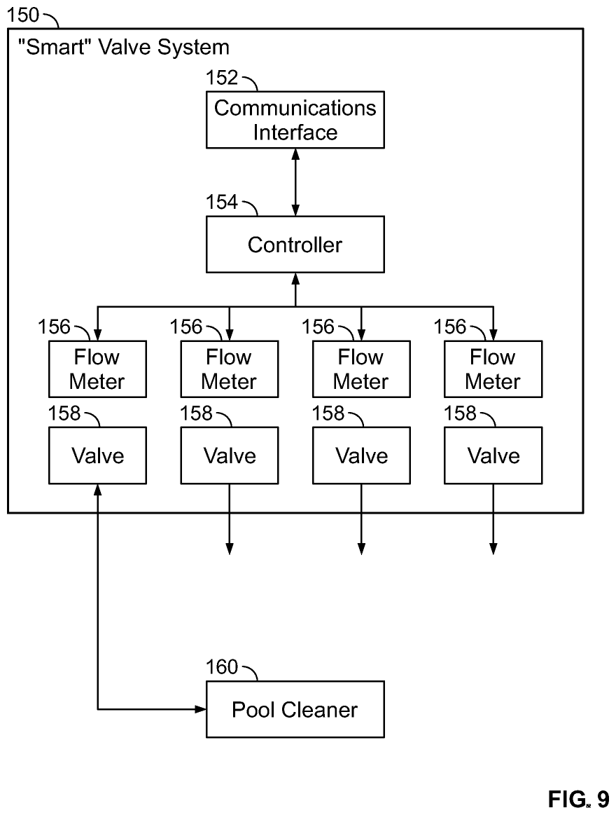

FIG. 9 is a block diagram of a fourth embodiment of the smart valve system of the present disclosure, wherein the smart valve system allows for control and optimization of a pool cleaner in fluid communication with the smart valve system. As can be seen, the smart valve system 150 is in fluidic communication with a pool cleaner 160 via a valve 158 of the smart valve system 150. As with other embodiments, the smart valve system 150 includes one or more flow meters 156, a controller 154, and a communications interface 152. The valve 158 controls the flow of fluid to or from the pool cleaner 160. It is noted that the various monitoring and control functions of the controller 154 discussed herein need not be stored in the controller 154, and indeed, such control functions could be stored remotely from the smart valve system 150 (e.g., in a remote “cloud” server in communication with the smart valve system 150 via the communications interface 152, or in a smart phone software application in communication with the smart valve system 150). In such circumstances, the smart valve system 150 could be remotely monitored and controlled (e.g., via the cloud server, smart phone application, or some other control source).

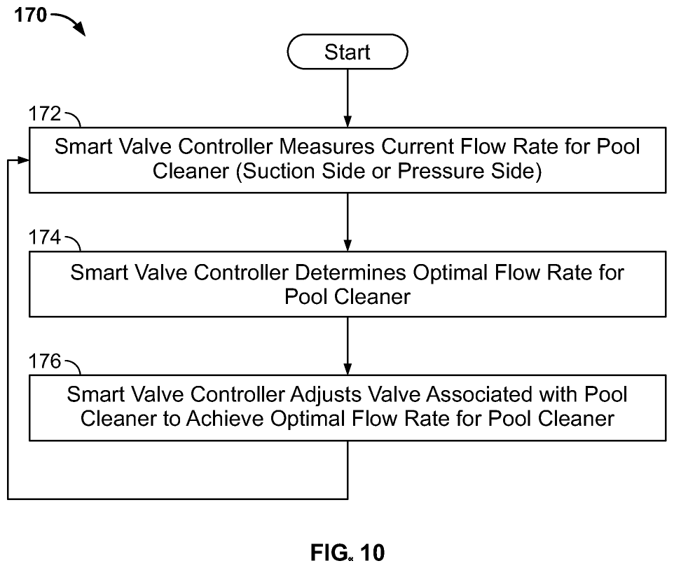

FIG. 10 is a flowchart, indicated generally at 170, illustrating steps carried out by the system of FIG. 9. Beginning and step 172, the smart valve controller 154 measures a current flow rate for the pool cleaner 160. Such a measurement can be made by one of the flow meters 156 of the smart valve system 150. Next, instep 174, the smart valve controller 154 determines an optimal flow rate for the pool cleaner 160. Finally, instep 176, the smart valve controller 154 adjust the valves 158 to achieve an optimal flow rate for the pool cleaner 160. It is noted that the pool cleaner 160 could be either a suction type pool cleaner or a pressure type pool cleaner.

The features discussed in connection with FIGS. 9-10 deliver a programmed flow rate for a suction cleaner that is in the optimal range for performance. If the suction cleaner does not have sufficient flow, it doesn't move or pick up debris properly. If the suction cleaner has too much flow, it moves too quickly and misses picking up debris. Pressure cleaners typically have a regulator to set the manufacturer's recommended pressure. With the features of FIGS. 9-10, the regulator could be eliminated since the smart valve system delivers the recommended flow rate for the cleaner to provide optimal performance. This eliminates the cost of the regulator, eliminates the need to set the pressure at installation, and maintains the proper flow rate even when the filter gets dirty (thereby promoting consistent flow).

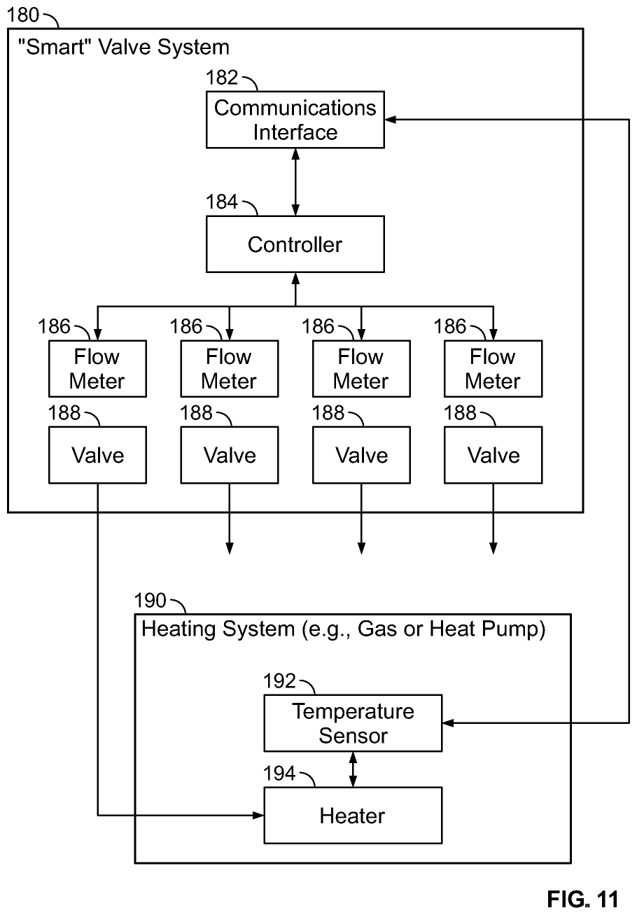

FIG. 11 is a block diagram of a fifth embodiment of the smart valve system of the present disclosure, wherein the smart valve system controls and optimizes operation of a gas heater in fluid communication with the smart valve system. As shown, the smart valve system 180 includes a communications interface 182 that receives temperature information from the heating system 190 via a temperature sensor 192 of the heating system 190. The temperature information is processed by the controller 184, which also controls one or more valve controllers associated with one or more valves 188. As with other embodiments, the smart valve system 180 also includes one or more flow meters 186 for measuring fluid flow rates through one or more fluid branches of the smart valve system 180. The heating system 190 includes a heater 194 that heats water supplied by one of the fluid branches of the smart valve system 180. The heater 194 could be any suitable type of heater, such as a gas heater, an electric heater, a heat pump, or other type of heater for heating pool or spa water. It is noted that the various monitoring and control functions of the controller 184 discussed herein need not be stored in the controller 184, and indeed, such control functions could be stored remotely from the smart valve system 180 (e.g., in a remote “cloud” server in communication with the smart valve system 180 via the communications interface 182, or in a smart phone software application in communication with the smart valve system 180). In such circumstances, the smart valve system 180 could be remotely monitored and controlled (e.g., via the cloud server, smart phone application, or some other control source).

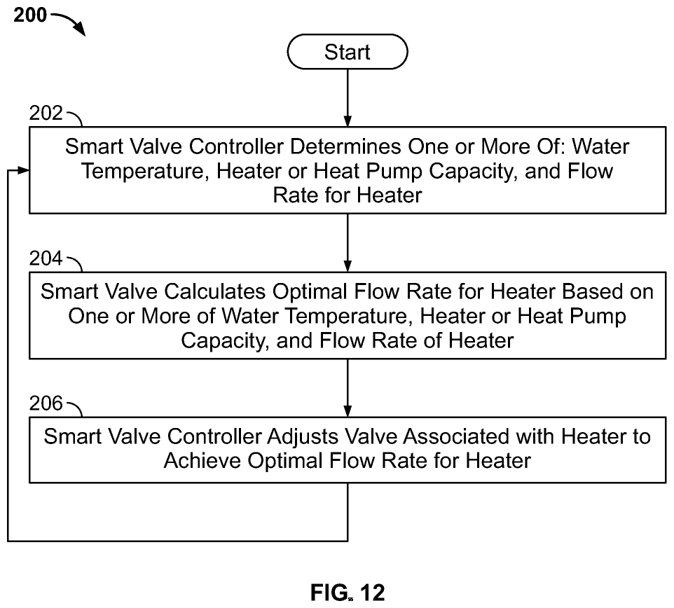

FIG. 12 is a flowchart, indicated generally at 200, illustrating processing steps capable of being carried out by the system of FIG. 11. Beginning in step 202, the smart valve controller 184 determines one or more of a water temperature, a heater or heat pump capacity, or a flow rate of the heater 194. Next, in step 204, the smart valve controller 184 calculator an optimal flow rate for the heater 194 based on one or more of water temperature, heater or heat pump capacity, or a flow rate of the heater 194. The flow rate of the heater 194 could be measured using one or more of the flow meters 186 of the smart valve system 180. Finally, in step 206, the smart valve controller 184 adjust a valve position associated with a valve 188 in fluid communication with the heating system 190 to achieve an optimal flow rate for the heater 194.

The features discussed in connection with FIGS. 11-12 can provide the optimal flow rate through the gas heater or heat pump based on a manufacturer's recommendation. Excess flow results in unnecessary head loss when the heater is not running. Additionally, flowing water through the heater/heat pump all the time leads to degradation in the heat exchanger (copper erosion, scale build up, etc.). The smart valve system addresses these issues by delivering the optimal flow rate of water through a heater based on water temperature, heater/heat pump capacity, and/or flow rate.

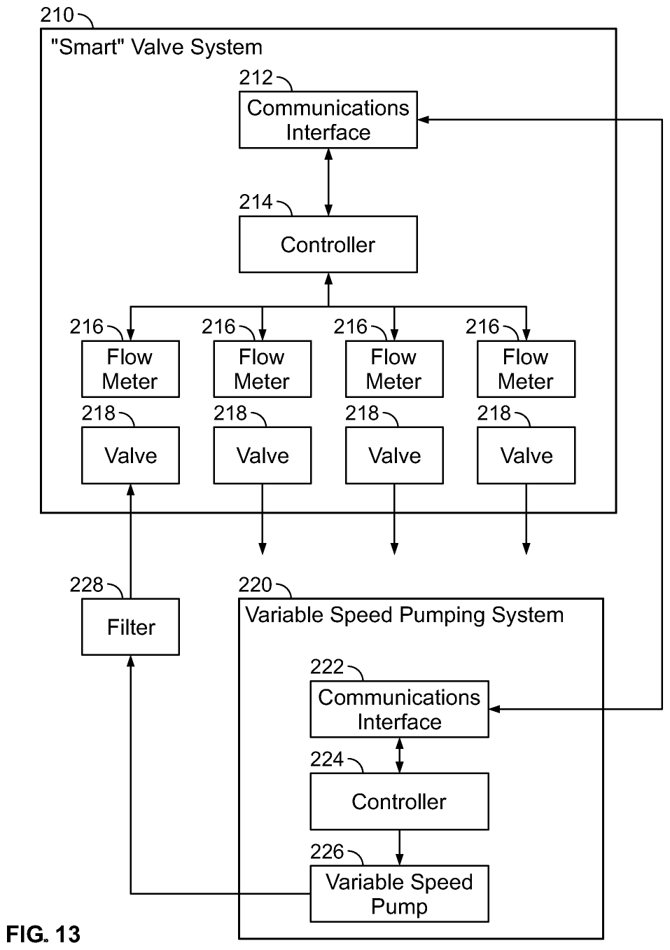

FIG. 13 is a block diagram illustrating a sixth embodiment of the smart valve system of the present disclosure, wherein the smart valve system detects dirty filter conditions. As can be seen, the smart valve system 210 includes a communications interface 212 that communicates with a second communications interface 222 of a variable speed pumping system 220. Communications could be achieved using any suitable communications protocol, including, but not limited to, a serial RS-485 communications protocol and an associated data connection. As with other embodiments, the smart valve system 210 includes a controller 214, one or more flowmeters 216, and one or more valves 218 that can be controlled by one or more valve controllers under control of the controller 214. The variable speed pumping system 220 includes a controller 224 and a variable speed pump 226 that supplies fluid (such as pool/spa water) to be filtered by a filter 228. An output of the filter 228 is in fluid communication with one of the valves 218 of the smart valve system 210, for subsequent distribution to one or more pool or spa components in fluid communication with the smart valve system 210. It is noted that the various monitoring and control functions of the controller 214 discussed herein need not be stored in the controller 214, and indeed, such control functions could be stored remotely from the smart valve system 210 (e.g., in a remote “cloud” server in communication with the smart valve system 210 via the communications interface 212, or in a smart phone software application in communication with the smart valve system 210). In such circumstances, the smart valve system 210 could be remotely monitored and controlled (e.g., via the cloud server, smart phone application, or some other control source).

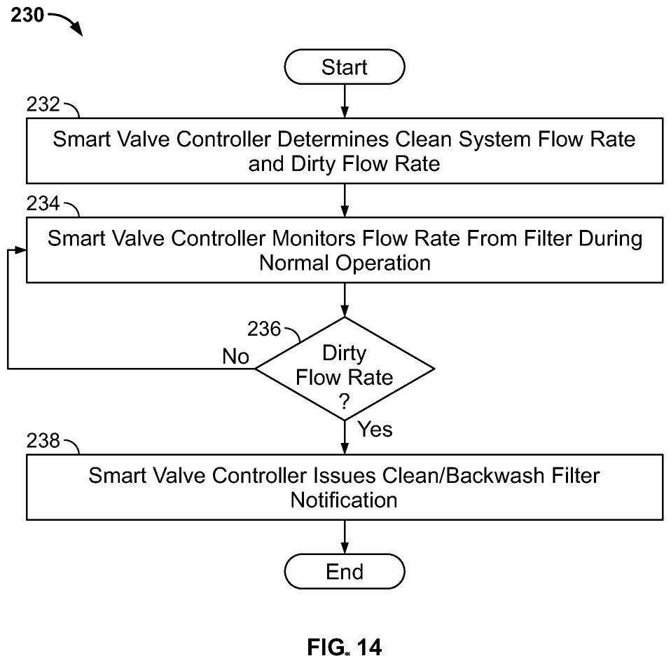

FIG. 14 is a flowchart, indicated generally at 230, illustrating steps capable of being carried out by the system of FIG. 13. Beginning in step 232, the smart valve controller 214 determines a clean system flow rate and a dirty system flow rate associated with the filter 228. Next, in step 232, the smart valve controller 214 monitors a flow rate from the filter 228 during normal operation. Such flow rate could be measured using one of the flow meters 216 of the smart valve system 210. Next, a determination is made at step 236 as to whether a dirty flow rate has been sensed. If a negative determination has been made, control returns to step 234. Otherwise, step 238 occurs, wherein the smart valve controller 240 issues a clean/backwash filter notification. Such notification could be by way of an audio or visual indication displayed or generated by the smart valve system 210, or through some other communications means. Further, the notification could be transmitted via the communications interface 212 of the smart valve system 210 to one or more remote devices, such as a pool/spa control system, a remote computer system, a server, a cloud-based control system, a mobile telephone, or other suitable device.

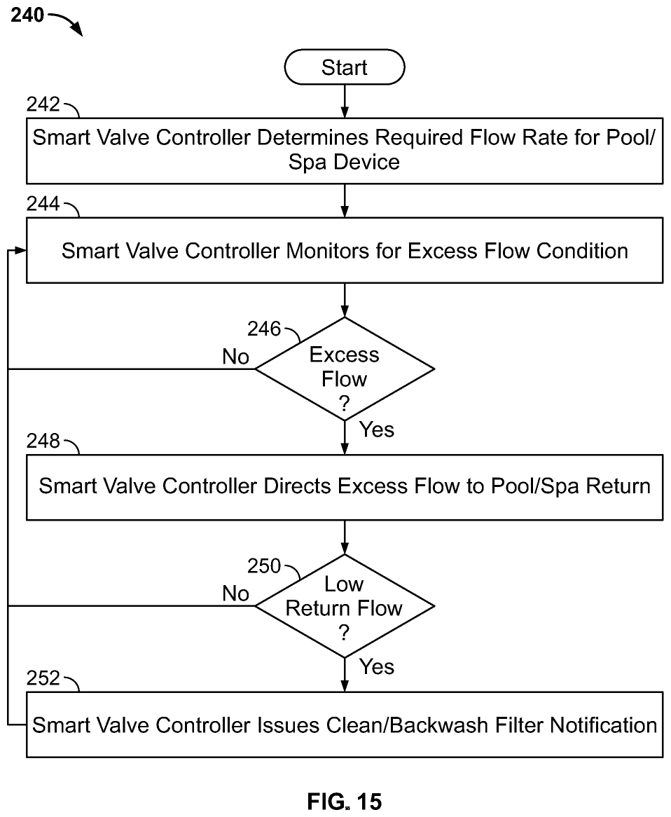

FIG. 15 is a flowchart, indicated generally at 240, illustrating additional steps capable of be carried out by the system of FIG. 13. Beginning in step 242, the smart valve controller 214 determines a required flow rate for a pool or spa device. Next, in step 244, the smart valve controller 214 monitors for an excess flow condition. In step 246, a determination is made as to whether an excess flow condition exists. If a negative determination is made, control returns to step 244. Otherwise, step 248 occurs, where in the smart valve controller 214 directs the excess flow to a return (e.g., fluid outlet) of a pool or a spa. Next, a determination is made in step 250 as to whether a low return flow condition exists. If not, control returns to step 244. Otherwise, step 252 occurs, wherein in the smart valve controller 214 issues a clean/backwash filter notification. As discussed in connection with FIG. 14, such a notification could be provided in a variety of ways.

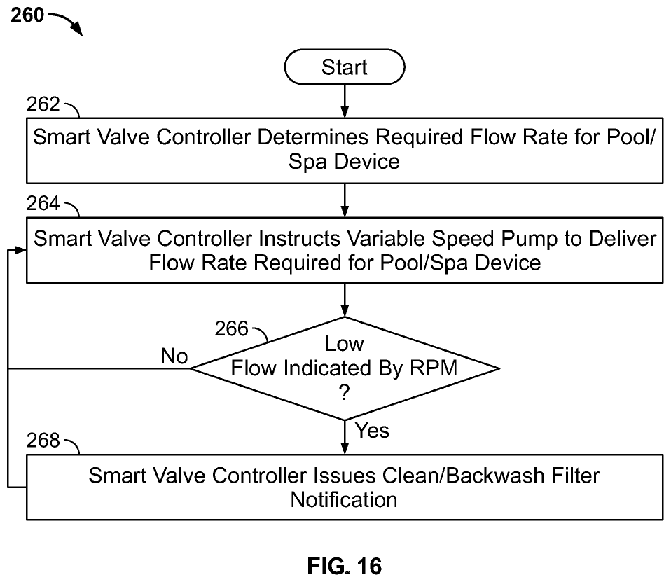

FIG. 16 is a flowchart, indicated generally at 260, illustrating further processing steps capable of being carried out by the system of FIG. 13. Beginning in step 262, the smart valve controller 214 determines a required flow rate for a pool or spa device. Next, in step 264, the smart valve controller 214 instructs the variable speed pumping system 220 to deliver a required flow rate for the pool or spa device. Such instruction could be transmitted by way of the communications interfaces 212, 222, discussed above. Next, a determination is made in step 266 as to whether a low flow condition is indicated by the current speed (RPM) of the variable speed pump system 220. If a negative determination is made, control returns to step 264. Otherwise, step 268 occurs, wherein in the smart valve controller 214 issues a clean or backwash filter notification in any of the ways discussed herein.

The features discussed in connection with FIGS. 13-16 can set a flow rate reduction threshold to indicate a filter needs to be backwashed or cleaned. A clean system flow rate is determined during priming when the pump is flowing 100% (3450 RPM). A dirty filter flow rate reduction (e.g., 10 GPM) is set, and when the same pump and valve conditions are active and the flow rate is 10 GPM lower, the system can provide a “Clean/Backwash Filter” notification to the pool owner or servicer. A condition other than priming can be used, using the same principle of recording the flow rate with a clean filter and detecting a reduced flow rate. In “Bleeder Mode,” the smart valve can be configured to deliver a fixed flow rate where excess flow (defined as flow that exceeds what is needed for the water features, cleaner, heater, salt cell, etc., that are active) is directed to the pool/spa return. In this mode, the water directed to the return acts as a variable buffer or bleeder since its flow isn't tied to a water feature or other device. When the pool return flow rate reduces to a programmed threshold, the “Clean/Backwash Filter” notification is sent. Further, the variable speed pump can be controlled to deliver only the flow needed by the water features, cleaner, heater, salt cell, etc. and very little flow is directed to the pool return. This variable speed pump mode (“VSP Mode”) would utilize the pump speed to GPM mapping mentioned above. In this embodiment, the same flow rate reduction would be used but it would be translated to RPM. When the VSP RPM increased to a programmed level corresponding to flow, the “Clean/Backwash Filter” notification would be delivered.

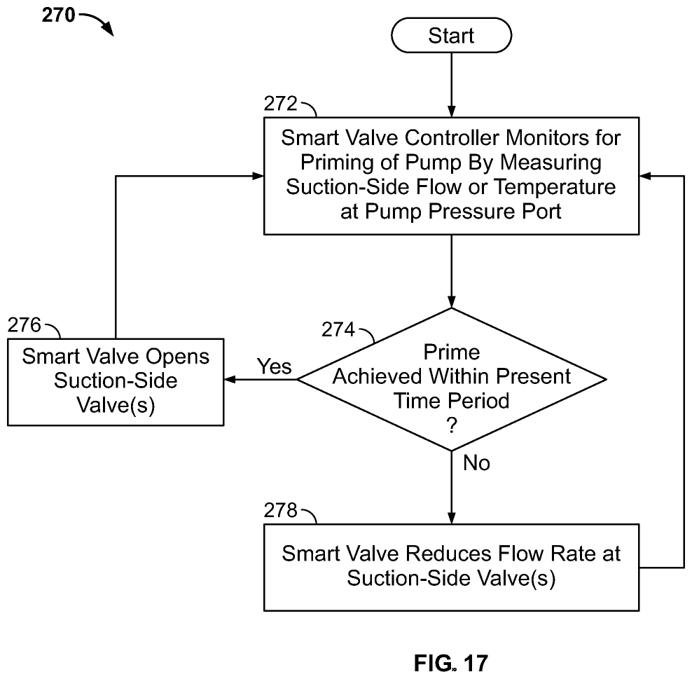

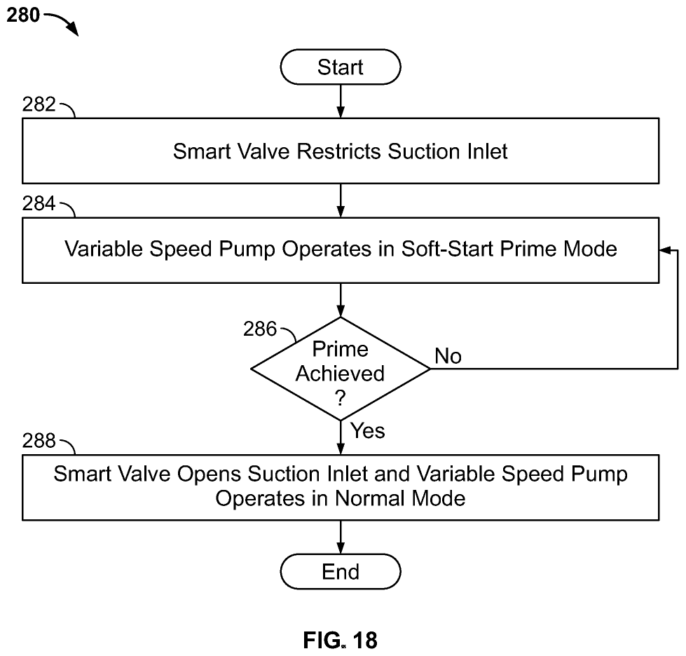

FIGS. 17-18 are flowcharts illustrating a seventh embodiment of the smart valve system of the present disclosure, wherein the smart valve system assists a priming operation of a pump in fluid communication with the smart valve system. In particular, FIG. 17 is a flowchart, indicated generally at 270, illustrating processing steps capable of being carried out by the smart valve system for assisting a variable speed pumping system to achieve prime. Beginning in step 272, the smart valve controller 214 monitors for priming of the variable speed pump 226 by measuring a suction side flow or a temperature of the pump at a pump pressure port of a variable speed pump existing 220. Next, a determination is made at step 274 as to whether prime has been achieved by the variable speed pump 226 within a preset time. If a positive determination is made, step 276 occurs, where in the smart valve controller 214 opens a suction side valve of the smart valve system 210 in fluid communication with the suction side of the variable speed pumping system 220. Such a suction side valve could be any of the valves 218 of the smart valve system 210. Otherwise, if a negative determination is made, step 278 occurs, wherein the smart valve system 210 reduces a flow rate at the suction side valve by operating a valve actuator associated with such valve.

FIG. 18 is a flow chart, indicated generally at 280, illustrating additional steps capable of being carried out by the smart valve system of the present disclosure for assisting a variable speed pump system to achieve prime. Beginning in step 282, the smart valve system 210 restricts a suction inlet associated with the variable speed pumping system 220. Such a restriction could be achieved by slowly closing one of the valves 218 of the smart valve system 210 in fluid communication with the suction inlet of the variable speed pumping system 220. Next, in step 284, the smart valve controller 214 instructs the variable speed pumping system to operate the variable speed pump 226 in a “soft-start” prime mode. Such instruction could be transmitted by the controller 214 to the controller 224 of the variable speed pumping system 220 via the communications interfaces 212, 222. In step 286, a determination is made as to whether prime has been achieved. If a negative determination has been made, control returns to step 284. Otherwise step 288 occurs, wherein the smart valve system 210 opens the suction inlet and the variable speed pump 226 is commanded to operate in a normal mode. Such command could be transmitted to the variable speed pumping system 220 from the smart valve controller 214 via the communications interfaces 212, 222.

The features of FIGS. 17-18 allow for priming of the pump to be detected by flow measurement and/or temperature sensing in the pump pressure port. If priming does not happen within a preset time period, the smart valve can reduce the flow rate of the suction-side valves (e.g., suction inlets, skimmers, suction cleaners, etc.) to effectively reduce the suction side plumbing size (for example, from 2″ to 1.5″). It is known that reducing the plumbing diameter to the suction inlet of the pool pump will improved its ability to prime (because of less volume to pull vacuum). After the pump has primed, the smart valve system can then slowly open up the suction side valves. The aforementioned “soft-start” mode could start up at a speed less than 3450 RPM to prime. In such circumstances, the smart valve system can restrict the suction inlet to allow the lower pump speed to effectively prime the pump. The smart valve system could achieve this by only pulling water from skimmers (for example, with a restricted valve position) and then sequentially gradually open the valves for the other suction inlets to allow them to prime. Because 100% speed of the pump is much louder, the soft-start mode would be noticeably quieter than other pumps that have to start at 100% speed for priming.

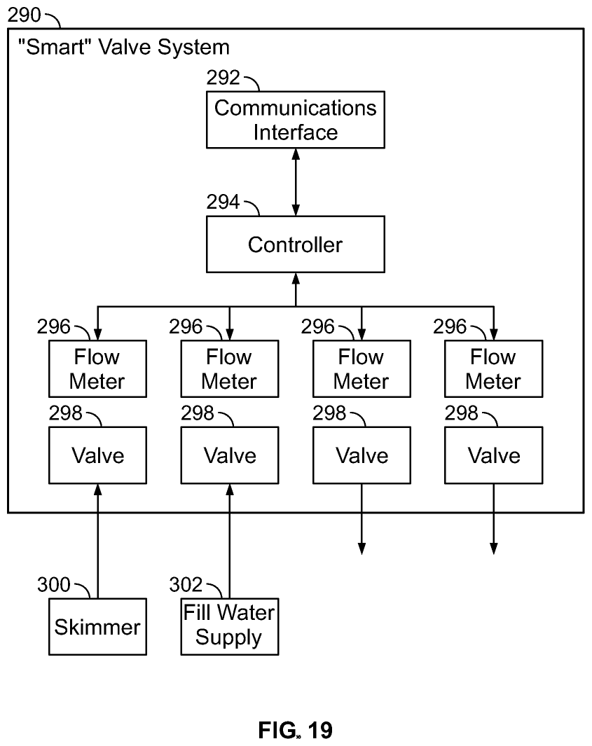

FIG. 19 is a block diagram illustrating an eighth embodiment of the smart valve system of the present disclosure, wherein the smart valve system detects low pool water conditions and automatically remedies such conditions. As shown, the smart valve system 290 is in fluid communication with one or more skimmers 300 via one or more valves 298. Additionally, the smart valve system 290 is in fluid communication with a fill water supply 302 via one of the valves 298 of the smart valve system 290. As with other embodiments discussed herein, the smart valve system 290 includes a communications interface 282, a controller 294, and one or more flowmeters 296. It is noted that the various monitoring and control functions of the controller 294 discussed herein need not be stored in the controller 294, and indeed, such control functions could be stored remotely from the smart valve system 290 (e.g., in a remote “cloud” server in communication with the smart valve system 290 via the communications interface 292, or in a smart phone software application in communication with the smart valve system 290). In such circumstances, the smart valve system 290 could be remotely monitored and controlled (e.g., via the cloud server, smart phone application, or some other control source).

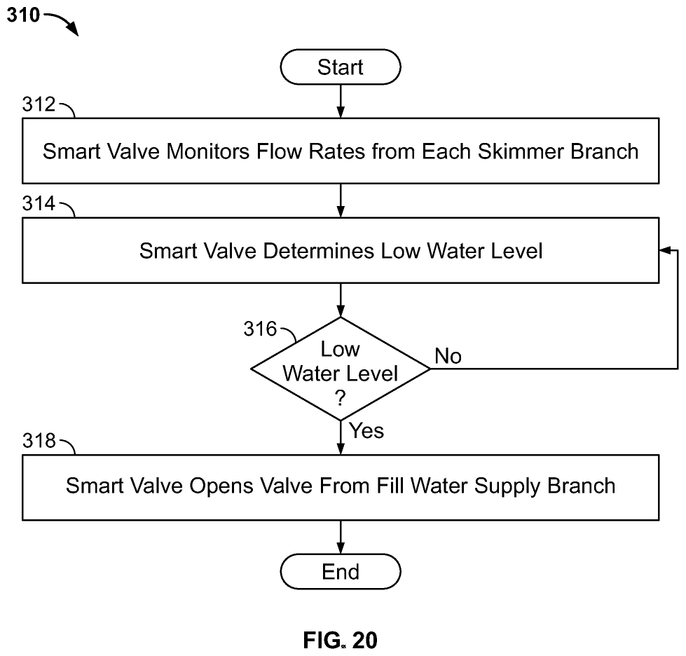

FIG. 20 is a flow chart, indicated generally at 310, illustrating processing steps carried out by the system of FIG. 19. Beginning in step 312, the smart valve controller 294 monitors flow rates from each skimmer branch in fluid communication with the smart valve system 290. Such flow rates could be measured by one or more of the flow meters 296 which measure flow rates through one or more of the valves 298 in communication with one or more of the skimmers 300. Next, in step 314, the smart valve controller 294 determines a low water level. Such level could be pre-programmed into the smart valve system, or it could be dynamically calculated by the smart valve system in response to sensed conditions associated with a pool or a spa. In step 316, a determination is made as to whether a low water level condition exists. If a negative determination is made, control returns to step 314. Otherwise, step 318 occurs, wherein the smart valve system 290 opens one of the valves 298 in fluid communication with the fill water supply 302 in order to fill the pool or spa with water and to rectify the low water condition.

The features discussed in connection with FIGS. 19-20 could periodically check for low pool water level by directly monitoring suction flow through each skimmer individually. Low pool water will be detected when flow is low (versus baseline full pool mapping) or when air is detected (inconsistent or choppy flow meter readings). When low pool water is detected, an external water source can feed water to the pool until the flow meter readings are stable and consistent. The external water source could be city water connected a port on the smart valve system, and can function as an autofill feature.

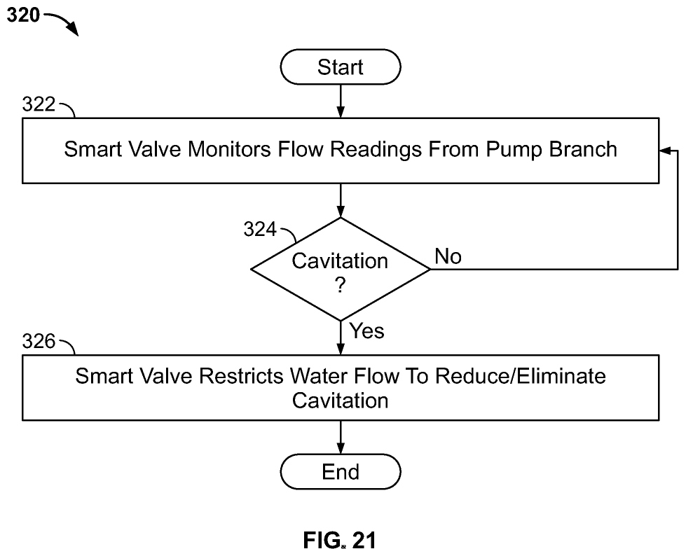

FIG. 21 is a flowchart, indicated generally at 320, illustrating a ninth embodiment of the smart valve system of the present disclosure, wherein the smart valve system detects and mitigates pump cavitation. Beginning in step 322, the smart valve system monitors flow readings from a fluid flow path associated with a pool or spa pump. For example, such a measurement could be made using a flow meter of the smart valve system to measure flow through one of the valves of the smart valve system that is in fluid communication with a pool or spa pump. Next, in step 324, a determination is made as to whether cavitation has been detected. If a negative determination is made, control returns to step 322. Otherwise, instep 326, the smart valve restricts water flow to the pump to reduce and or eliminate cavitation. The flow meter can detect cavitation through erratic flow readings indicating a mix of air and water, and the smart valve system can gradually restrict the flow of water until the cavitation is eliminated (e.g., when flow meter readings are stable).

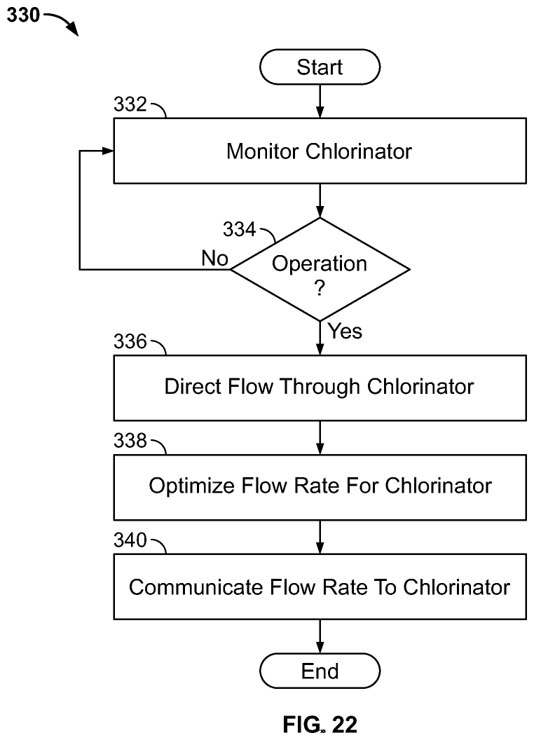

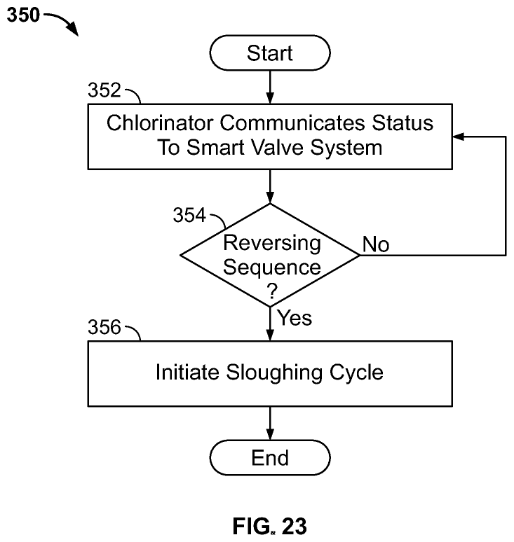

It is noted that the smart valve system of the present disclosure could be in fluidic and electrical communication with a chlorinator (e.g., an electrolytic (“salt”) chlorination system), and can control various aspects of such systems as described now in connection with FIGS. 22-23.

FIG. 22 is a flowchart, indicated generally at 330, illustrating processing steps carried out by the smart valve system in order to provide for control and optimization of a chlorinator. In step 332, the smart valve system monitors operation of the chlorinator (e.g., via a serial RS-485 communications link or other communications link described herein). In step 334, the smart valve system determines whether the chlorinator requires operation. If not, control returns to step 332. Otherwise, step 336 occurs, wherein smart valve system directs flow (via operation of an associated valve and valve actuator) through the chlorinator. By selectively controlling flow to the chlorinator only when the chlorinator is in operation, the system extends the life of the chlorinator (e.g., salt cell) by reducing scale build-up on the chlorinator blades since water will only flow through the chlorinator when it is required. In step 338, the smart valve system determines an optimal flow rate for the chlorinator, and controls operation of one or more of the valves and valve actuators so as to deliver the optimal flow rate to the chlorinator. In step 340, the optimal flow rate is transmitted to the chlorinator. The optimal flow rate can be determined such that the rate is not so low as to damage the chlorinator (salt) cell and not so high as to carry hydrogen bubbles away too quickly. Advantageously, since the flow rate is transmitted to the chlorinator, the chlorinator does not require a dedicated flow meter (thus reducing costs). Moreover, the chlorinator can adjust its operation (e.g., output level) based on the transmitted flow rate.

FIG. 23 is a flowchart, indicated generally at 350, illustrating additional processing steps capable of being carried out by the smart valve system in order to allow for periodic cleaning (“sloughing”) of a chlorinator. Beginning in step 352, the chlorinator communicates status information (relating to operation of the chlorinator) to the smart valve system. In step 354, the smart valve system determines whether the chlorinator is in a reversing sequence based on the status information transmitted from the chlorinator. If a negative determination is made, step 352 is repeated. Otherwise, step 356 occurs, wherein the smart valve system causes one or more of the valves and associate valve actuator to operate in sloughing cycle until the reversing sequence of the chlorinator is complete. In the sloughing cycle, one or more of the valves and associated valve actuators is operated to increase the flow rate to the chlorinator while the chlorinator is in the reversing sequence. Such higher rate of flow through the chlorinator assists with more effectively breaking off scale build-up in the chlorinator, thereby promoting better cleaning of the chlorinator and enhancing the life of same.

It is noted that the smart valve system discussed herein can perform other functions beyond those discussed herein in connection with FIGS. 1-23. For example, a water feature in fluid communication with the smart valve system could be operated by the smart valve system to achieve a fountain effect by periodically building pressure up and then releasing the pressure. In such circumstances, the smart valve system could restrict one of the ports (pressure side) in fluid communication with a pump and simultaneously increase pump speed in order to build up pressure, and then rapidly open the same port in order to produce a burst of water at the water feature. Such features could also be used to dynamically control flow rates during step changes in flow (e.g., to accommodate schedule changes).

Further, the smart valve system could be operated to optimize in-floor cleaning by an in-floor cleaning system in fluid communication with the smart valve system. In such circumstances, the smart valve system could direct flow from a main drain when one or more in-floor cleaning nozzles are active in order to achieve maximum debris cleaning by the drain. Additionally, flow could be directed by the smart valve system from one or more skimmers only when an in-floor cleaning system is being operated in an agitation mode, to achieve maximum debris cleaning by the skimmers. Still further, flow could be directed to skimmers when in-floor cleaning nozzles are not active, in order to achieve maximum surface debris collection, thereby preventing debris from sinking to the floor and obviating the need for collection by the drain.

Still further, the smart valve system (e.g., suction side) could be operated to periodically direct flow isolated from one skimmer and then, after a time, direct the next skimmer until each skimmer is individually selected. A baseline can be determined when the skimmer basked is clean, and a reduction in flow rate indicates that the skimmer basket is sufficiently full of debris that it should be cleaned. This allows the system to not only detect dirty skimmer basket, but also to direct cleaning to the baskets that require cleaning (e.g., in circumstances where wind blows leaves into one end of the pool, filling up one skimmer basket, while leaving other skimmer baskets empty). This feature can also be used to check a suction cleaner to see if it has been blocked with large debris and is not operating efficiently as the set flow rate.

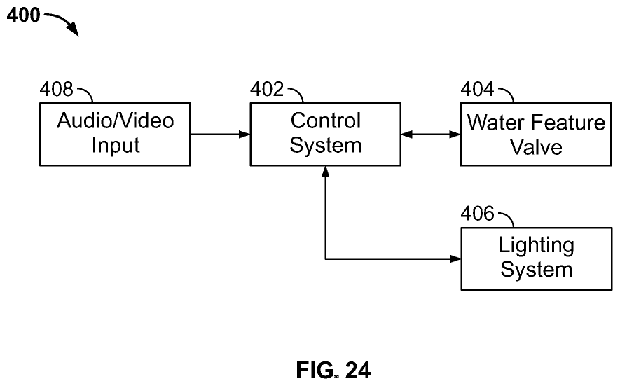

FIG. 24 is a diagram illustrating a twelfth embodiment of the smart valve system of the present disclosure, indicated generally at 400, wherein the smart valve system provides for audio/visual control of a water show. The system 400 can include a control system 402 that controls one or more of a water feature valve 404 and a lighting system 406, and receives one or more audio or video inputs 408. The control system 402 could be positioned near the water feature valve 404 and/or the lighting system 406, or at a pool/spa equipment pad, or even remotely from pool/spa equipment (e.g., it could be embodied as a software application executing on a smart phone in communication with the water feature valve 404 and/or the lighting system 406, and/or as an application remotely executing on a cloud server or other computing system in communication with the water feature valve 404 and/or the lighting system 406). The control system 402 can control operation of the water feature valve 404 and/or the lighting system 406 to create a water show that includes water features and lighting effects that are synchronized to sound and/or video playing (e.g., in response to the audio/video input 408, which could be a song or video playing in a backyard, on a smart phone in communication with the control system 402, or from some other media source). A fully immersive experience could be provided, such that the system 402 saves in memory backpressure factors already computed and ready for usage by the water feature valve 404, and then executes those factors in response to the audio/video input 408. Additionally, the water/light show could be augmented with an audio/video that is played at the same time as the water/light show.

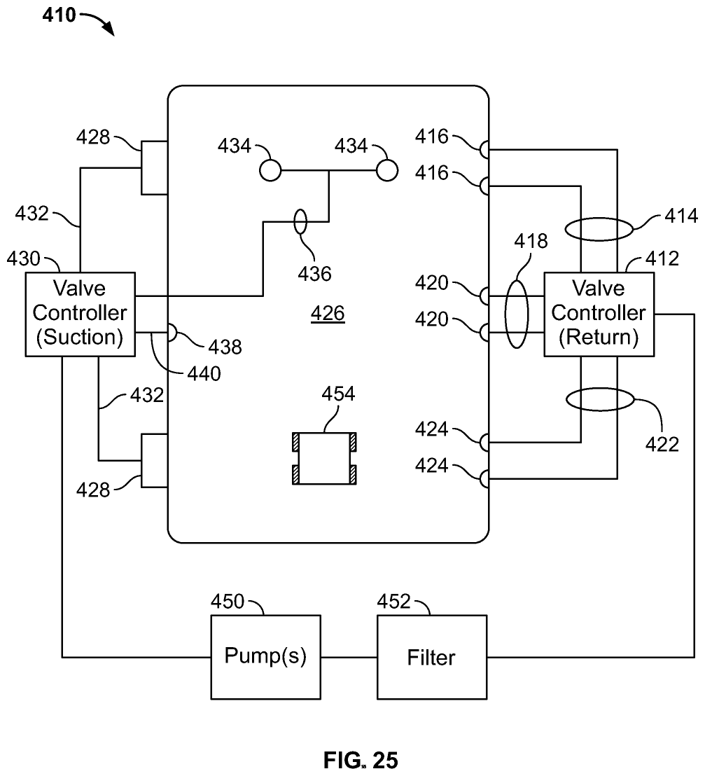

FIG. 25 is a diagram illustrating a thirteenth embodiment of the smart valve system of the present disclosure, indicated generally at 410, wherein the smart valve system includes suction and return valve controllers 430 and 412, respectively, and associated components for providing various skimming and cleaner control operations. Specifically, the return valve controller 412 can selectively supply filtered water to a pool/spa 426 via a first set of return fluid lines 414 and a first bank of return jets 416 in fluid communication with the controller 412. The return valve controller 412 can also selectively supply filtered water to the pool/spa 426 via a second set of return fluid lines 418 and an associated second bank of return jets 420, which could be positioned at another location in the pool/spa 426 (e.g., toward the center of the pool/spa 426). Still further, the return valve controller 412 can selectively supply filtered water to the pool/spa 426 via a third set of fluid return lines 422 and an associated third bank of return jets 424, which could be positioned at yet another location in the pool/spa 426. The return valve controller 412 could be supplied with filtered water from a filter 452, which is in turn supplied by one or more pumps 450.

The suction valve controller 430 could be in fluid communication with a plurality of suction outlets of a pool/spa. For example, the suction valve controller could be in fluid communication with a first skimmer 428 via suction line 433 and can receive water to be filtered from the first skimmer 428. Additionally, the valve controller 430 could be in fluid communication with one or more main floor drains 434 via suction fluid line 436, as well as a vacuum port 438 via suction fluid line 440. Still further, the suction valve controller 430 could be in fluid communication with a second skimmer 428 via suction line 432. The suction valve controller 430 selectively draws water to be filtered from one or more of the skimmers 428, the main drain(s) 434, and/or the vacuum port 438, using suction generated by the pump 450. It is noted that the valve controllers 412, 430 could include the components discussed in the other embodiments of the present disclosure, e.g., valves, valve actuators, a controller (e.g., microprocessor), a communications interface, and various sensors (e.g., pressure sensors, flow sensors, temperature sensors, etc.).

The system 410 could be operated in a “super skim” mode, a specific bank of the return jets 416, 420, and 424 is selectively actuated to direct debris to one or more of the skimmers 428. Additionally, the return valve controller 412 could boost flow to a specific one of the return banks 416, 420, and 424 while closing other returns, so as to enhance skimming operation. Still further, the suction valve controller 430 could boost suction flow to one of the skimmers 428 while closing the other skimmer and/or the main drain(s) 434 and/or the vacuum port 438 in order to enhance skimming operation. Such operations can create an effective “super skim” mode of operation that can be scheduled as desired. Also, the system can generate one or more alerts when one or more of the controllers 412, 430 detects that one or more of the skimmers 428 are full, and in such circumstances, can also partially open one or more of the drains 434 or monitor for a drop in skimmer flow/pressure or an increase in suction flow/pressure.

The valve controllers 412, 430 can also be operated to automate and optimize operation of cleaners, such as the cleaner 454 depicted in FIG. 25. For example, the suction valve controller 430 can be programmed to stop flow to the main drain(s) 434 to release trapped debris and to keep the cleaner 454 from getting stuck on the drain(s) 434 (which could apply to any type of cleaner such as a suction cleaner, a pressure cleaner, or a robotic cleaner). Additionally, the controller 430 could close additional skimmers if the user desires to use a suction port to create a dedicated suction port with maximum suction pressure. All skimmers 428 could be opened to skim the surface while the cleaner 454 operates to clean pool floors, walls, and waterline. Still further, the controller 430 could adjust flow to a dedicated cleaner suction port, and could also control the speed of the pump 450, to achieve optimum flow in a cleaning mode of operation. Examples of this include closing or opening skimmers or boosting or reducing pump speed depending on user preference, as well as maintaining an optimum flow as a leaf canister, pump basket, or filter becomes full. Additionally, the system can alert a user that the leaf canister needs to be emptied or that a pump basket or filter requires cleaning.

The system 410 can also be programmed to schedule cleaning cycles wherein the valve controllers 412, 430 are selectively operated to achieve such cleaning cycles. For example, if a cleaning mode is activated, one or more of the controllers 412, 430 can command the pump 450 to operate at a particular speed, and can selectively close one or more of the skimmers 428, drain(s) 434, or vacuum ports 438 to achieve a desired cleaning cycle. Additionally, the system can set the cleaning time of day and duration to match user preferences and/or debris loads. A cleaning mode (“scene”) could be activated by a weather event or seasonal condition (e.g., rain storm, wind event, seasonal change, presence of leaves in the pool (e.g., in the fall), presence of pollen and tree stamen in the pool (e.g., in the spring)). Still further, the cleaning mode could be tailored to achieve a cleaning performance level or energy efficiency. For example, each cleaning mode could be linked to the time of day or direct input from a power company when power cost is high or low, or when power grid demand is high or low.

The controller 430 could also be operated to extend the life of a suction cleaner and to optimize energy efficiency. For example, the controller 430 could close a dedicated suction port when the system is not in an active cleaning cycle, which can prevent internal components of a cleaner from spinning and causing wear of components (e.g., bearings, gears, etc.) during a low-flow circulation/filtration condition when flow is present but not high enough to move the cleaner around the pool/spa or effectively pick up debris.

The controller 412 could be operated to assist with automation and operation of the cleaner 454 (in the event that the cleaner 454 is a pressure cleaner in fluid communication with the valve controller 412 via one of the return jets 416, 420, or 424). Such automation could involve usage of a booster pump, if desired. The scheduling, timing, user preferences, energy efficiencies, and extended component life could be controlled by the system in such circumstances. If a booster pump is not utilized, the controller 412 can close all returns, water features, and water falls on the pressure side and can open a single, dedicated pressure return port to direct all flow to the cleaner 454. If a booster pump is utilized, the controller 412 can optimize operation of the cleaner 454 using a flow meter or pressure sensor. Also, the controller 412 can adjust pump/valve settings to maintain desired performance.

In the event that the cleaner 454 is a robotic cleaner, the controllers 412 and/or 430 can assist with operation of the robotic cleaner. For example, the controller 430 can stop flow from the drain(s) 434 to release trapped debris and to prevent the cleaner from getting stuck on the drain(s) 434. Also, the controller 430 can open all of the skimmers 428 and command a booster pump to activate, and can use the robotic cleaner's flow at the water surface to push debris to pool walls and into skimmers. If available, and open bank of water surface and step return ports can be operated by the controller 412 to direct floating debris to one or more of the skimmers 428. Still further, the system 410 can communicate with a central pool/spa control system such that other pool functions/optimizations can occur when the robotic cleaner is in a cleaning cycle. For example, the central control system can adjust cleaner scheduling and optimization of a robotic cleaner's cleaning cycle. For example, a user-initiated one-time robotic cleaning operation can be scheduled with a user-initiated cleaning cycle, and/or a user-initiated one-time robotic cleaning operation can trigger a pool cleaner's cleaning cycle.

The cleaner 454 can be programmed to dump debris into the drain(s) 434. In such circumstances, the controller 430 is configured to open one of the drains 434, whereupon the cleaner 454 travels to the drain 434 and positions itself over the drain 434. Then, the cleaner 454 empties its debris canister into the drain in order to empty the canister. The controller 430 can then sense when a pump basket/filter requires emptying after the debris is sucked away by the drain 434 (e.g., due to changes in flow/pressure sensed by the controller 43), and can generate an alert when cleaning is necessary.

In the event that the cleaner 454 is a battery-powered robotic cleaner that requires periodic recharging of the battery, the controller 430 can open one of the main drains 434, whereupon the cleaner can drive over and position itself above one of the drains 434. Suction flow from the drain can then be used to generate energy (e.g., by causing a turbine of the cleaner 454 to spin in order to generate electricity) which can be used to recharge the battery of the cleaner 454.

It is further noted that both the suction valve controller 430 and the return valve controller 412 could be operated to assist the pool cleaner 454 in performing floor sweeping functions. For example, the controller 412 could close or reduce (or optimize) return jet flow settings to reduce pool water body turbulence during sweeping, Also, the controller 430 could boost suction to a debris-accepting main drain 434. If the cleaner 454 has no debris container, it can be operated to create jets or sections of pressurized laminar flow at the pool floor, such that the cleaner can move around and “sweep” debris toward the drain 434. As noted above, the cleaner can be battery-powered and can charge on the main drain (e.g., after a sweeping cycle). Finally, a user can be alerted to when the pump basket or filter requires cleaning, after the drain 434 has removed the debris.

It is further noted that the valve controllers 412, 430 can be operated so as to winterize the pool/spa 426, with or without the use of a variable speed pump. For example, the controllers 412, 430 can close specific valves while keeping others open, and can then run the pump to keep water circulating. With the pump off, one of the controllers 412, 430 can open an air bleeder valve to allow water to drain out of the body. Also, the controllers 412, 430 can operate to perform freeze protection for the pool or spa, and/or operate in a safety or service mode.

It is noted that one or more of the controllers 412, 430 could include one or more flow sensors for providing multi-purpose feedback and communicating with a control system as a whole. For example, the controllers 412, 430 could detect a flow obstruction (or, flow gain), which can then be utilized by a control system to initiate a messaging scheme. Specifically, one of the fluid lines in a controller 412, 430 could be used at a hot tub specifically to detect whether a person is sitting near (or on) a return jet or obstructing a jet, which causes flow fluctuations that are detectable by the controller 412 or 430. This detected condition can then be utilized to operate other equipment and/or to initiate different modes of operation. Additionally, multiple jets could be configured such that each jet is dedicated to controlling a specific function (e.g., one jet can control pump speed, a second jet can control heating, a third jet can control lighting, etc.), by the controllers 412, 430 detecting flow or pressure changes in each jet. Indeed, specific obstruction methods could be used to control various equipment (e.g., if flow at a jet is obstructed for 5 seconds, then intermittently for 3 seconds, such detected condition could trigger control of one type of equipment or mode, while a different obstruction pattern could trigger control of a different type of equipment or mode). A user-friendly interaction with a jet can allow for multi-purpose inputs/controls via a single jet, allowing for full control of apparatus simply by the user moving his or her hand across a jet. Around the pool pad, deck jets or recirculation jets could be used for such control as well. The specific response by the system to user input could be assigned by the user and/or the controller. Such an arrangement could eliminate an air switch in the system for basic on/off control of equipment.

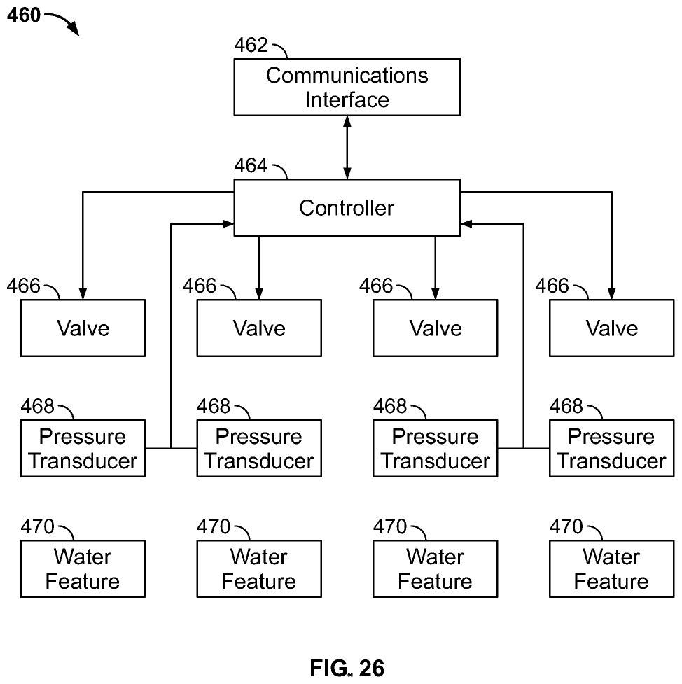

FIG. 26 is a diagram illustrating a fourteenth embodiment of the smart valve system of the present disclosure, indicated generally at 460, wherein the smart valve system includes pressure transducers 468 for controlling flow of various fluid paths, without requiring flow meters. Specifically, the smart valve system 460 includes a controller 464, a plurality of valves 466 including associated valve actuators (which are controlled by the controller 464), and one or more water features 470 that are in fluid communication with and controlled by the one or more valves 466. A communications interface 462 allows the controller 464 to communicate with another pool/spa device, a central pool/spa control system, a cloud-based pool/spa control system, a smart telephone, etc. Also, it is noted that the monitoring and control functions performed by the controller 464 could be performed remote from the system 460, e.g., by another pool/spa device, a central pool/spa control system, a cloud-based pool/spa control system, a smart telephone, etc.

The valves 466 can turn the water features 470 on or off based on preset flow rates set by the user, which are sensed by the pressure transducers 468 without the use of flow meters. Specifically, a valve 466 can initiate flow to a respective water feature 470 by opening the valve (in response to a command sent by the controller 464). If a particular one of the water features 470 requires more or less flow, a respective valve 466 connected to such water feature can adjust flow accordingly. When a satisfactory flow has been achieved for such water feature, the controller 464 can sense and store a pressure associated with the satisfactory flow using an associated pressure transducer 468, and the same can be done with all other water features 470, valves 466, and pressure transducers 468. The water features 470 can then be turned on and off by the user, and the valves 466 can be used to balance the correct flow to each water feature 470 based on the target pressure stored for the respective water feature. This approach advantageously allows the water features 470 to be turned on and off without the use of flow meters, thereby reducing production costs and complexities.

It is additionally noted that a flow controlling valve could be included in the system 460, for use with multiple stages of filtration. For example, a multi-stage filtration system that has filter stages of varying degrees of filtration (coarse versus fine) could vary the rate at which water is sent through the different stages, using the system 460. This could allow filter stages to last longer, and/or the user can have control over how clean/clear a pool is. Still further, the valve could bypass a portion of the flow to a reverse osmosis filter (or the like) to remove/control the concentration of total dissolved solids (TDS) without the need to drain hundreds/thousands of gallons of water from the pool during a year. Paired with sensors to monitor the TDS levels the valve could increase/decrease flow to maintain optimum pool chemistry. Still further, a “shock mode” could be provided which bypasses all filters and equipment and boosts flow to circulate the shock without damaging the pool equipment. Finally, a maximum filtration mode could be initiated after a party.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A smart valve system, comprising:
a valve actuator for actuating a valve;
a sensor for monitoring a flow rate through the valve;
a controller in communication with the valve actuator and the sensor; and
a communications interface in communication with the controller and a variable speed pumping system,
wherein the controller is configured to measure the flow rate through the valve and controls operation of the variable speed pumping system based on the measured flow rate.

2. The smart valve system of claim 1, wherein the sensor comprises a pressure sensor for detecting pressure changes at the valve, the controller controlling operation of the valve actuator in response to the detected pressure changes at the valve.

3. The smart valve system of claim 1, wherein the controller controls operation of the valve using the detected pressure changes to avoid undershoot or overshoot conditions.

4. The system of claim 1, wherein controller transmits the flow rate to the variable speed pumping system, the variable speed pumping system calibrating a flow rate of the variable speed pumping system in response to the flow rate through the valve.

5. The system of claim 1, wherein the controller is configured to measure the flow rate through the valve, measure a speed of the variable speed pump, map the speed to the measured flow rate, transmit a pump speed command to the variable speed pumping system, and dynamically control a valve position of the valve to achieve a desired flow rate for the valve.

6. The system of claim 1, wherein the controller is configured to measure the flow rate through the valve, determine a full speed of the variable speed pumping system, set a valve position of the valve to a desired flow rate, and instruct the variable speed pumping system to reduce a pump speed until a lowest acceptable pump speed is reached by the variable speed pumping system.

7. The system of claim 1, wherein the controller is configured to monitor the flow rate and issue a clean or backwash filter notification if the flow rate indicates that a filter in fluid communication with the variable speed pump is dirty.

8. The system of claim 1, wherein the controller is configured to monitor the flow rate, determine if the flow rate indicates excess flow, and directs the excess flow to a return of a pool or a spa.

9. The system of claim 1, wherein the controller is configured to determine a required flow rate for a pool or spa device, instruct the variable speed pumping system to deliver the required flow rate, monitor a speed of the variable speed pumping system, determine whether the speed indicates a low flow condition, and issue a clean or backwash filter notification in response to the low flow condition.

10. The system of claim 1, wherein the controller is configured to operate the valve actuator to restrict suction through the valve, instruct the variable speed pumping system to operate in a soft-start mode, determine whether the variable speed pumping system achieves prime, and operating the valve actuator to open the valve and instructing the variable speed pumping system to operate in a normal mode if the variable speed pumping system achieves prime.

11. The system of claim 1, wherein the controller is configured to determine from monitoring of the flow rate whether the pump is experiencing cavitation, and operating the valve actuator to restrict water flow through the valve to reduce the cavitation.

12. The system of claim 1, wherein the controller controls operation of the valve actuator and the variable speed pump to produce at least one burst of water by a water feature.

13. The system of claim 1, wherein the sensor is a pressure sensor and the controller detects changes in flow rates through the valve based on pressure changes detected by the pressure sensor and without requiring a flow meter.

14. The system of claim 13, wherein the controller controls operation of at least one of the valve or the variable speed pumping system in response to detected changes in flow rates.

15. The system of claim 14, wherein the valve is in fluid communication with a water feature, and at least one of the valve or the variable speed pumping system controls flow to the water feature in response to the detected changes in flow rates.

16. A smart valve system, comprising:
a valve actuator actuating a valve, said valve in fluid communication with a pool cleaner;
a flow meter monitoring a flow rate through the valve; and
a controller in communication with the valve actuator and the flow meter,
wherein the controller is configured to measure the flow rate through the valve, determine an optimal flow rate for the pool cleaner, and adjust the valve to achieve the optimal flow rate for the pool cleaner.

17. The smart valve of claim 16, wherein the controller controls operation of the valve to direct flow from the main drain when one or more in-floor cleaning nozzles of a pool or a spa are active.

18. The smart valve of claim 16, wherein the controller controls operation of the valve to direct flow from the skimmer when an in-floor cleaning system of a pool or a spa is being operated in an agitation mode.

19. The smart valve of claim 16, wherein the controller controls operation of the valve to direct flow from the skimmer when an in-floor cleaning system of a pool or a spa is not active.

20. A smart valve system, comprising:
a return valve controller in fluid communication with a plurality of return jets, the plurality of return jets of a pool or spa; and
a suction valve controller valve controller in fluid communication with a plurality of suction outlets of the pool or spa,
wherein at least one of the return valve controller or the suction valve controller are operable to direct debris present in the pool or the spa to at least one of the plurality of suction outlets of the pool or spa or to augment operation of a pool cleaner operating in the pool or the spa.

21. The system of claim 20, wherein the suction valve controller is operable to optimize operation of the pool cleaner by stopping flow to a main drain to release trapped debris and to prevent the pool cleaner from being stuck on the main drain.

22. The system of claim 20, wherein at least one of the suction valve controller or the return valve controller is operable to during a cleaning cycle of the pool cleaner, during a pre-defined time of day, in response to power cost or power grid demand, or in response to a weather event or a seasonal condition.

23. The system of claim 20, wherein the suction valve controller controls flow to reduce wear of components of the pool cleaner.

24. The system of claim 20, wherein the suction valve controller activates at least one of the plurality of suction outlets to remove debris from the pool cleaner when the pool cleaner is proximal to the at least one of the plurality of suction outlets.

25. The system of claim 20, wherein at least one of the suction valve controller or the return valve controller is operable to assist the pool cleaner with performing a floor sweeping function.

26. The system of claim 20, wherein at least one of the suction valve controller or the return valve controller is operable to winterize the pool or spa or perform freeze protection for the pool or the spa.

27. The system of claim 20, wherein the suction valve controller is operable to detect a flow obstruction and control operation of at least one pool or spa component based upon detection of the flow obstruction.

28. A smart valve system, comprising:
a valve actuator actuating a valve;
a sensor for monitoring a flow rate through the valve;
a controller in communication with the valve actuator and the sensor; and
a communications interface in communication with the controller and a heating system,
wherein the controller is configured to measure the flow rate through the valve and control operations of the heating system based on the measured flow rate.

29. The smart valve system of claim 28, wherein the controller calculates an optimal flow rate for the heating system based on the one or more of a water temperature, a capacity of the heating system, and a flow rate of the heating system, and adjust the valve to achieve the optimal flow rate for the heating system.

30. The smart valve system of claim 28, wherein the heater is a solar heater and the controller determines a programmed flow rate for the solar heater, operates the valve to achieve the programmed flow rate for the solar heater, measures a water temperature of the solar heater, determines an optimal flow rate to maximize heat transfer from the solar heater, and operates the valve to achieve the optimal flow rate.

31. A smart valve system, comprising:
a plurality of valve actuators for actuating a plurality of valves;
a controller in communication with the plurality of valve actuators; and
a communications interface in communication with the controller and a data cable, said data cable communicating a formatted message from a pool or spa control system, said communications interface converting the formatted message from the pool or spa control system into individual valve control signals, the controller controlling the plurality of valve actuators using the individual valve control signals.

32. The smart valve system of claim 31, wherein the communications interface reads outputs of one or more relays of the pool or spa control system and generates the formatted message based on the outputs of the one or more relays of the pool or spa control system.

33. A smart valve system, comprising:
a valve actuator actuating a valve, the valve in fluid communication with a chlorinator;
a sensor for monitoring a flow rate through the valve; and
a controller in communication with the valve actuator and the sensor;
wherein controller is configured to determine whether the chlorinator is in operation, operate the valve actuator to direct fluid flow through the chlorinator if the controller determines that the chlorinator is in operation, determine an optimal flow rate for the chlorinator, and operate the valve actuator to deliver the optimal flow rate to the chlorinator.

34. The smart valve system of claim 33, wherein controller is configured to determine whether the chlorinator is operating in a reversing sequence based on status information communicated from the chlorinator to the manifold control system, and to operate the valve actuator in a sloughing cycle of operation when the chlorinator is operating in the reversing sequence.

35. A smart valve system, comprising:
a plurality of valves each having an associated valve actuator and a sensor, one of said plurality of valves in fluid communication with a skimmer and another of said plurality of valves in fluid communication with a water supply; and
a controller in communication with the valve actuator and the sensor,
wherein the controller controls operation of the plurality of valve actuators to selectively operate the skimmer and monitors flow rates of the skimmer to determine whether the skimmer requires cleaning.

36. The smart valve system of claim 35, wherein the controller is configured to monitor a flow rate from the skimmer, determine whether a low water condition exists, and opening the another of said plurality of said valves to allow water from the water supply to fill a pool or a spa in response to the low water condition.

37. A smart valve system, comprising:
a water feature valve for controlling water flow to a water feature; and
a control system in communication with the water feature valve, the control system receiving one or more audio or video inputs and controlling the water flow to the water feature using the water feature valve in response to the one or more audio or video inputs.

38. The smart valve system of claim 37, further comprising a lighting system in communication with the control system, the control system controlling operation of the lighting system in response to the one or more audio or video inputs.
